(19) United States
(12) Patent Application Publication
(10) Pub. No.: US 2020/0092110 A1
(43) Pub. Date: Mar. 19, 2020

(54) ELECTRONIC SIGNATURE SYSTEM, ELECTRONIC SIGNATURE SERVER AND ELECTRONIC SIGNATURE METHOD

(71) Applicant: SZ DJI TECHNOLOGY CO., LTD., Shenzhen (CN)

(72) Inventors: Guofang ZHANG, Shenzhen (CN); Yun YU, Shenzhen (CN); Renli SHI, Shenzhen (CN)

(21) Appl. No.: 16/692,686

(22) Filed: Nov. 22, 2019

Related U.S. Application Data
(63) Continuation of application No. PCT/CN2017/086444, filed on May 27, 2017.

(51) Int. Cl. H04L 9/32; G06F 16/23; G06F 16/25; H04L 29/06

(52) U.S. Cl. CPC H04L 9/3247; H04L 9/3263; H04L 63/0853; H04L 9/3231; G06F 16/252; G06F 16/2379

(57) ABSTRACT

An electronic signature system includes an electronic signature terminal configured to issue an electronic signature request and submit certificate information of a certificate, an electronic signature server configured to generate an electronic signature based on the electronic signature request and bind the electronic signature with the certificate information, and a certificate database configured to store the certificate information bound with the electronic signature.

### CROSS-REFERENCE TO RELATED APPLICATION

This application is a continuation of International Application No. PCT/CN2017/086444, filed on May 27, 2017, the entire content of which is incorporated herein by reference.

### TECHNICAL FIELD

The present disclosure relates to the electronic signature technology and, more particularly, to an electronic signature system, an electronic signature server, and an electronic signature method.

### BACKGROUND

With a rapid development of unmanned aerial vehicle (UAV) industry, the number of unmanned aerial vehicles (UAVs) launched onto the market and the number of UAV users have dramatically increased. Various countries have successively introduced or are soon to introduce management policies to regulate a healthy development of the UAV industry. The relevant management policies or drafts require training and certification of the UAV users, authentication and approval of UAV operations, and issuing certificate of authenticities (COAs), special flight operations certificates (SFOCs), or other airworthiness certificates for UAV systems.

However, due to the large number of the UAVs and the users and relatively limited personnel and resources of relevant management agencies, it is difficult for the management agencies to conduct an on-site inspection, registration and issuance of a UAV flying license, the COA, or the airworthiness certification. In addition, because flight activities of small UAVs are particularly flexible, the users cannot carry the required certificates with them all the time.

### SUMMARY

In accordance with the disclosure, there is provided an electronic signature system including an electronic signature terminal configured to issue an electronic signature request and submit certificate information of a certificate, an electronic signature server configured to generate an electronic signature based on the electronic signature request and bind the electronic signature with the certificate information, and a certificate database configured to store the certificate information bound with the electronic signature.

Also in accordance with the disclosure, there is provided an electronic signature server including a storage device storing a plurality of instructions, and a processor coupled to the storage device and configured to execute the plurality of instructions to receive an electronic signature request and a certificate, generate an electronic signature based on the electronic signature request, bind the electronic signature with the certificate, and store the certificate bound with the electronic signature to a certificate database.

Also in accordance with the disclosure there is provided an electronic signature method including receiving an electronic signature request and a certificate, generating an electronic signature based on the electronic signature request, binding the electronic signature with the certificate, and storing the certificate bound with the electronic signature to a certificate database.

### BRIEF DESCRIPTION OF THE DRAWINGS

FIG. 1 is a schematic architectural diagram of an example electronic signature system consistent with embodiments of the disclosure.

FIG. 2 is schematic diagram of an example electronic signature terminal consistent with embodiments of the disclosure.

FIG. 3 is schematic diagram of an example electronic signature server consistent with embodiments of the disclosure.

FIG. 4 is a schematic flow chart of an example binding process of an electronic signature method consistent with embodiments of the disclosure.

FIG. 5 is a schematic flow chart of an example querying process of an electronic signature method consistent with embodiments of the disclosure.

FIG. 6 is a schematic flow chart of an example authentication process of an electronic signature method consistent with embodiments of the disclosure.

### DESCRIPTION OF MAIN COMPONENTS AND REFERENCE NUMERALS

| | |
|---|---|
| Electronic signature system | 1 |
| Electronic signature terminal | 10 |
| First signature system | 100 |
| Interface module | 101 |
| First receiving module | 102 |
| First sending module | 103 |
| First communication device | 104 |
| First storage device | 105 |
| First processor | 106 |
| Display | 107 |
| Input device | 108 |
| Electronic signature server | 20 |
| Second signature system | 200 |
| Login module | 201 |
| Signature module | 202 |
| Binding module | 203 |
| Query module | 204 |
| Authentication module | 205 |
| Second communication device | 206 |
| Second storage device | 208 |
| Second processor | 209 |
| Third communication device | 207 |
| Certificate database | 30 |

Hereinafter, example embodiments will be described with reference to the accompanying drawings described above.

### DETAILED DESCRIPTION OF THE EMBODIMENTS

In order to provide a clearer illustration of purposes, technical solutions, and advantages of disclosed embodiments, example embodiments will be described with reference to the accompanying drawings. It will be appreciated that the described embodiments are some rather than all of the embodiments of the present disclosure. Other embodiments conceived by those having ordinary skills in the art on the basis of the described embodiments without inventive efforts should fall within the scope of the present disclosure.

The systems described above are merely illustrative. For example, the division of units or modules may only be a logical function division, and there may be other ways of dividing the units. It can be appreciated that the term “comprising” or “including” is open-ended and does not exclude other elements or processes that are not listed, and the singular element listed does not exclude the use of the plural elements. The plurality of units or devices recited in the system claims can be integrated into one unit or device implemented by software or hardware. The terms “first,” “second,” or the like, are used to denote names and not to indicate any particular order.

Unless otherwise defined, all the technical and scientific terms used herein have the same or similar meanings as generally understood by one of ordinary skill in the art. As described herein, the terms used in the specification of the present disclosure are intended to describe exemplary embodiments, instead of limiting the present disclosure. The term “and/or” used herein includes any suitable combination of one or more related items listed.

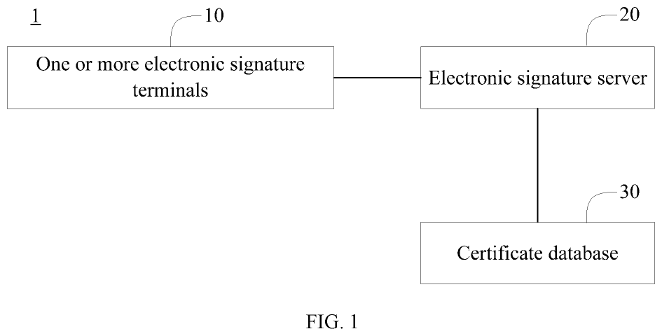

FIG. 1 is a schematic architectural diagram of an example electronic signature system 1 consistent with the disclosure. As shown in FIG. 1, the electronic signature system 1 includes, but is not limited to, one or more electronic signature terminals 10, an electronic signature server 20, and a certificate database 30. The one or more electronic signature terminals 10 are communicatively coupled to the electronic signature server 20, and the electronic signature server 20 is communicatively coupled to the certificate database 30. Each electronic signature terminal 10 can be configured to initiate a signature process according to a user operation, issue a signature request, a query request, or an authentication request, receive a user input, and transmit signature information of the user input to the electronic signature server 20. The signature request can be also referred to as an electronic signature request. The electronic signature server 20 can be configured to generate an electronic signature based on the signature request and save it to the certificate database 30. The electronic signature server 20 can be further configured to obtain the corresponding electronic signature and certificate from the certificate database 30 based on the query request, send them to the corresponding electronic signature terminal 10, and determine whether the user is certified based on the authentication request. For example, the certificate in the certificate database 30 can be searched for according to user information included in the authentication request obtained from the corresponding electronic signature terminal 10, and whether the user has the corresponding certificate can be determined. If it is determined that the user has the corresponding certificate, the user can be certified. The certificate database 30 can be configured to store various certificates, including, but not limited to, a personnel registration certificate, a UAV registration certificate, a ground station registration certificate, a UAV airworthiness certificate/UAV authentication certificate, a UAV operation certificate, and/or the like.

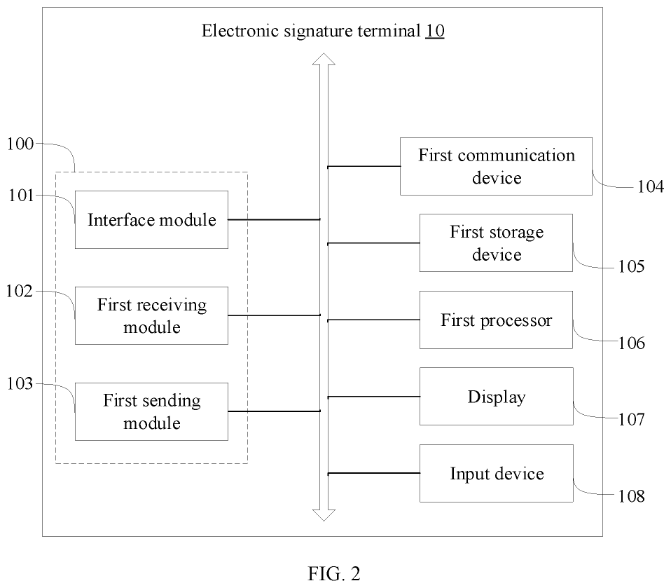

FIG. 2 is schematic diagram of an example electronic signature terminal 10 consistent with the disclosure. The electronic signature terminal 10 can include a smart terminal (e.g., a mobile phone, a tablet computer, a laptop computer, a desktop computer, or the like), a UAV remote controller, a ground station, or the like. As shown in FIG. 2, the electronic signature terminal 10 includes, but is not limited to, a first communication device 104, a first storage device 105, a first processor 106, a display 107, and an input device 108.

The first communication device 104 can be communicatively coupled to the electronic signature server 20, and a communication connection between the first communication device 104 and the electronic signature server 20 can include a wired connection or a wireless connection. The wired connection can include a connection via a communication port, for example, a universal serial bus (USB), a controller area network (CAN), a serial and/or other standard network connection, an inter-integrated circuit (I2C) bus, or the like. The wireless connection can employ any type of wireless communication technology, such as Bluetooth, infrared communication technology, wireless fidelity (Wi-Fi), cellular technology, satellite communication technology, broadcast communication technology, or the like. The cellular technology can include second generation (2G), third generation (3G), fourth generation (4G), or fifth generation (5G) mobile communication technology, or the like. The 3G and 4G technologies are based on mobile communication standards conforming to international standards promulgated by the International Telecommunications Union (ITU). The 3G and 4G technologies can provide information transmission rates from 200 kilobits (KBs) per second to several gigabits (GBs) per second, such that the 3G and 4G technologies can be suitable for transmitting high resolution images and videos with a large bandwidth. The 3G technology generally refers to a technology having a reliability and the data transmission rates satisfying the International Mobile Telecommunications 2000 (IMT-2000) standard. The commercial 3G systems generally include systems and radio interfaces based on spread spectrum radio transmission technologies, such as a Universal Mobile Telecommunications Service (UMTS) system standardized by the 3rd Generation Partnership Project (3GPP), a Wideband Code Division Multiple Access (W-CDMA) radio interface, and a Time Division Synchronous Code Division Multiple Access (TD-SCDMA) radio interface proposed by China, a High Speed Packet Access (HSPA) plus Universal Mobile Telecommunications Service (UMTS) release, a Code Division Multiple Access (CDMA) 2000 system, and an Evolution-Data Optimized (EV-DO). In addition, other technologies, such as Enhanced Data rates for GSM Evolution (EDGE), Digital Enhanced Cordless Telecommunications (DECT), and Mobile Worldwide Interoperability for Microwave Access (WiMAX) are also compliant with IMT-2000 and therefore also approved by the ITU as the 3G standards. Accordingly, the term “3G” as used herein includes, but is not limited to, any IMT-2000 compliant technology, including those described above.

The 4G technology refers to a technology conforming to the International Mobile Telecommunications Advanced (IMT-Advanced) specification, which can achieve a maximum speed of 100 megabits (MBs) per second for high-mobility communications, one gigabit (GB) per second in low-mobility communications. In October 2010, the ITU-approved 4G standards include enhanced Long Term Evolution (LTE) and enhanced Wireless MAN-Advanced. However, the 4G services released by some commercial operators are not fully compliant with the IMT-Advanced specifications, such as LTE, Mobile Microwave Access (WiMAX), and Time division LTE (TD-LTE). Accordingly, the term “4G” as used herein can include, but not limited to, the technologies not fully compliant with the IMT-Advanced specifications, such as LTE, Mobile WiMAX, TD-LTE, and the technologies conforming to the IMT-Advanced specifications. The 5G refers to a next-generation mobile communication standard that goes beyond the current 4G/IMT-Advanced standard.

The first storage device 105 can include an internal storage of the electronic signature terminal 10, for example, a hard disk or a memory, or can include a plug-in storage device, such as a plug-in hard disk, a smart memory card (SMC), and a security digital (SD) card, a flash card (Flash Card), or the like. In some embodiments, the first storage device 105 can also include both the internal storage and the plug-in storage device.

The first processor 106 can include, for example, a central processing unit (CPU), a microprocessor, or other data processing chip, and configured to perform the functions of the electronic signature terminal 10.

The display 107 can include, for example, a liquid crystal display (LCD), a light emitting diode (LED) display, an organic light-emitting diode (OLED), or other suitable display.

The input device 108 can include any suitable input device including, but not limited to, a mouse, a keyboard, a touch screen, or a contactless input device, such as a gesture input, a voice input, or the like. The input device 108 can be configured to receive the user input to initiate the signature process or issue the query request and the authentication request.

A first signature system 100 can be installed and operated in the electronic signature terminal 10. The first signature system 100 can include computer executable instructions in a form of one or more programs. The computer executable instructions can be executed by the first processor 106. In some embodiments, the first signature system 100 can be integrated and solidified in the first processor 106, or can be stored in the first storage device 105 independently of the first processor 106. As shown in FIG. 2, the first signature system 100 includes, but is not limited to, an interface module 101, a first receiving module 102, and a first sending module 103. A functional module may refer to a series of program instructions that can be executed by the first processor 106 of the electronic signature terminal 10 and can perform a certain function and be stored in the first storage device 105 of the electronic signature terminal 10.

The interface module 101 can be configured to provide a user interface (UI), and the UI can be displayed via the display 107.

The first receiving module 102 can be configured to receive input information from the input device 108. The received input information may include, but is not limited to, identification information of the user and signature information of the user. The identification information of the user can include, but not limited to, name, gender, identity (ID) card information, scene image and/or scene video, random verification code, or the like. The signature information of the user can include, but not limited to, an identification feature, such as a signature handwriting, a fingerprint (e.g., identification features of the fingerprint), or the like. The signature information can be also referred to as electronic signature information.

The first sending module 103 can be configured to send the identification information of the user and the signature information of the user to the electronic signature server 20 via the first communication device 104.

It can be appreciated that the first signature system 100 can be installed and run in the form of application software in the electronic signature terminal 10. In some other embodiments, the first signature system 100 may not be pre-installed in the electronic signature terminal 10, and the electronic signature terminal 10 can access a specific webpage through a web browser, such as, IE or Google Chrome, to open the first signature system 100 in a webpage form.

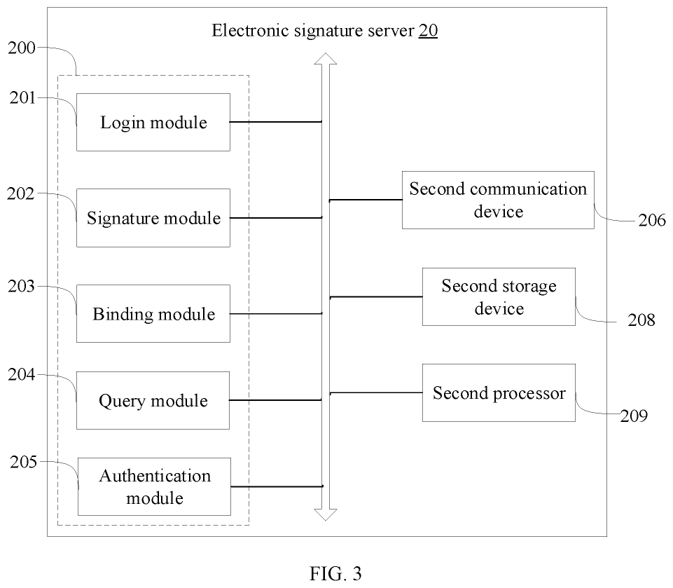

FIG. 3 is schematic diagram of another example electronic signature terminal 20 consistent with the disclosure. As shown in FIG. 3, the electronic signature server 20 includes, but is not limited to, a second communication device 206, a third communication device 207, a second storage device 208, and a second processor 209. The second communication device 206 can correspond to the first communication device 104, and include a wired and/or wireless communication device. The second communication device 206 can communicate with the first communication device 104 to realize the communication between the electronic signature terminal 10 and the electronic signature server 20.

The third communication device 207 can be similar to the second communication device 206 and configured to communicate with the certificate database 30 via, for example, the wired or wireless connection. The wired connection can include the connection via the communication port, such as the USB, the CAN, the serial and/or other standard network connection, the I2C bus, or the like. The wireless connection can employ any type of wireless communication technology, such as the Bluetooth, the infrared communication technology, the wireless fidelity (Wi-Fi), the cellular technology, the satellite communication technology, the broadcast communication technology, or the like. The cellular technology may include the mobile communication technology, such as the 2G, the 3G, the 4G, or the 5G mobile communication technology. In some embodiments, the third communication device 207 can be omitted, and the electronic signature server 20 and the certificate database 30 can be communicatively coupled via the second communication device 206.

The second storage device 208 can include an internal storage of the electronic signature server 20, such as, a hard disk or a memory, or can include the plug-in storage device, such as a plug-in hard disk, a smart memory card (SMC), a secure digital (SD) card, a flash card, or the like. The second storage device 208 can also include both the internal storage and the plug-in storage device. In some embodiments, the second storage device 208 can store a plurality of authentication scenarios.

The second processor 209 can be a central processing unit (CPU), a microprocessor, or other data processing chip and configured to perform the functions of the electronic signature server 20.

A second signature system 200 can be installed and operated in the electronic signature service 20 and include computer executable instructions in a form of one or more programs. The computer executable instructions can be executed by the second processor 209. In some embodiments, the second signature system 200 can be firmware in the second processor 209, or can be stored in the second storage device 208 independently of the second processor 209. As shown in FIG. 3, the second signature system 200 includes, but is not limited to, a login module 201, a signature module 202, a binding module 203, a query module 204, and an authentication module 205. A functional module may refer to a series of program instructions that can be executed by the second processor 209 of the electronic signature server 20 and that can perform a function and be stored in the second storage device 208 of the electronic signature server 20.

The login module 201 can be configured to receive a login request from the electronic signature terminal 10 via the second communication device 206, and return a login result according to login request information. For example, it the login request is allowed, the login result including “Login Successful” can be returned, if the login request is not allowed, and the login result including “Login Failure” can be returned. The login request information can include an account password or other identification features, such as sounds, gestures, or the like. The login module 201 can be configured to compare the identification features in the login request information with pre-stored identification features, and allow the login request if they are consistent, and not allow the login request if they are inconsistent.

The signature module 202 can be configured to receive, via the second communication device 206, the identification information of the user and the signature information of the user from the electronic signature terminal 10, and generate the electronic signature of the user according to the identification information of the user and the signature information of the user. Each user can correspond to a unique electronic signature. The identification information of the user can include, but not limited to, the name, gender, ID card information, scene image and/or scene video, random verification code, or the like. The signature information of the user can include, but not limited to, the identification features, such as the signature handwriting, the fingerprint, or the like.

The binding module 203 can be configured to receive, via the second communication device 206, a certificate of the user from the electronic signature terminal 10, and associate the certificate of the user with the electronic signature of the user. The certificate and the electronic signature that are bound together are stored in the certificate database.

The query module 204 can be configured to receive, via the second communication device 206, the query request of the user from the electronic signature terminal 10, and search for the certificate corresponding to the user stored in the certificate database 30 according to the authentication request of the user, and return the obtained certificate to the electronic signature terminal 10. For example, the query request can include the identification information of the user, and the query module 204 can search for the certificate stored in the certificate database 30 according to the identification information. In some embodiments, the query module 204 can compare the identification information of the user with the identification information included in the electronic signature bound with the certificate to determine whether the certificate matches the identification information of the user.

The authentication module 205 can be configured to receive the authentication request of the user from the electronic signature terminal 10 via the second communication device 206, and search for the certificate corresponding to the user according to the authentication request of the user to determine whether the user can pass the certification. For example, the authentication request can include the identification information of the user, and the authentication module 205 can query the certificate stored in the certificate database 30 according to the identification information. When the certificate matching the identification information of the user is found, the authentication module 205 can determine that the user passes the authentication. In some embodiments, the authentication module 205 can compare the identification information of the user with the identification information included in the electronic signature bound with the certificate to determine whether the certificate matches the user identification information.

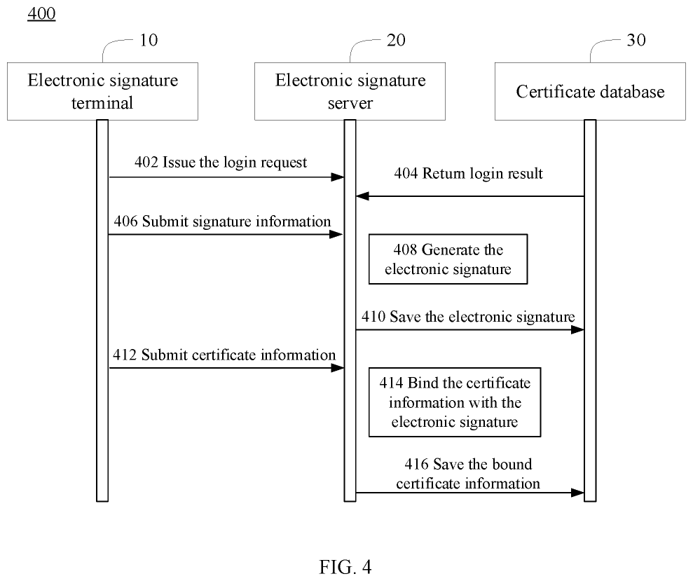

FIG. 4 is a schematic flow chart of an example electronic signature method 400 consistent with the disclosure. The electronic signature method 400 includes a binding process. An order of the processes in FIG. 4 can be changed according to different needs, and some processes may be omitted or combined.

As shown in FIG. 4, at 402, the electronic signature terminal 10 issues the login request according to the user operation. In some embodiments, the electronic signature terminal 10 can be installed with an electronic signature application, and when the electronic signature application is opened and the user name and password are inputted, the login request can be issued. In some embodiments, the electronic signature terminal 10 can enter an electronic signature interface via a predetermined web address, and when the electronic signature process is triggered by clicking one or more buttons on the electronic signature interface, the login request can be issued.

At 404, after receiving the login request, the electronic signature server 20 determines whether the user is allowed to log in. The login request information can include the account password or other identification features, such as the sounds, gestures, or the like. The login module 201 can compare the identification features in the login request information with the pre-stored identification features, and can allow the login request if they are consistent, and does not allow the login request if they are inconsistent.

At 406, the electronic signature terminal 10 submits signature information according to the user operation. The signature information can include, but not limited to, the identification information of the user and the signature information of the user. The identification information of the user can include, but not limited to, the name, gender, ID card information, scene image and/or scene video, random verification code, or the like. The signature information of the user can include, but not limited to, the identification feature, such as the signature handwriting, the fingerprint, or the like.

At 408, the electronic signature server 20 generates the electronic signature of the user according to the signature information of the user. Each user can correspond to a unique electronic signature.

At 410, the electronic signature server 20 saves the generated electronic signature to the certificate database 30.

At 412, the electronic signature terminal 10 submits certificate information via the first communication device 104. The certificate information can include, but not limited to, basic information of the certificate, an image of the certificate, and/or the like. The basic information of the certificate can include a main body of the certificate information (e.g., the main body of the driver's license is the driver, the main body of the airworthiness certificate is a UAV, or the like), a validity period of the certificate, an issuing entity of the certificate, or the like.

At 414, the electronic signature server 20 binds the certificate information received from the electronic signature terminal 10 with the electronic signature of the user. After the certificate information received from the electronic signature terminal 10 and the electronic signature of the user is bound, the certificate information can only be obtained if the electronic signature information of the user is consistent.

At 416, the electronic signature server 20 saves the certificate information bound to the electronic signature of the user to the certificate database 30.

In some other embodiments, the certificate database 30 and the electronic signature server 20 may be integrated into one apparatus, and the certificate database 30 can be a storage device arranged in the electronic signature server 20.

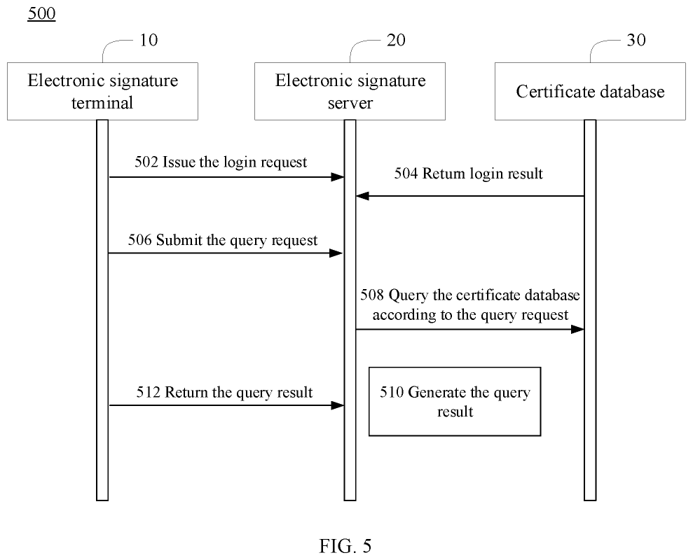

FIG. 5 is a schematic flow chart of another electronic signature method 500 consistent with the disclosure. The electronic signature method 500 includes a query process. An order of the processes in FIG. 5 can be changed according to different requirements, and some processes may be omitted or combined.

At 502, the electronic signature terminal 10 issues the login request according to the user operation. In some embodiments, the electronic signature terminal 10 can be installed with the electronic signature application, and when the electronic signature application is opened and the user name and password are inputted, the login request can be issued. In some embodiments, the electronic signature terminal 10 can enter the electronic signature interface via the predetermined web address, and when the electronic signature process is triggered by clicking the one or more buttons on the electronic signature interface, the login request can be issued.

At 504, after receiving the login request, the electronic signature server 20 determines whether the user is allowed to log in. The login request information can include the account password or other identification features, such as the sounds, gestures, or the like. The login module 201 can compare the identification features in the login request information with the pre-stored identification features, and can allow the login request if they are consistent, and does not allow the login request if they are inconsistent.

At 506, the electronic signature terminal 10 submits the query request according to the user operation. The query request can include, but not limited to, the identification information of the user, a type and/or name of the certificate to be searched for. In some embodiments, the type of the certificate can include, but not limited to, a registration certificate, an airworthiness certificate, an operator license, or the like. The registration certificate can include, but not limited to, a personnel registration certificate, a UAV registration certificate, and a ground station registration certificate. The airworthiness certificate can include a flight authority license or a certification certificate obtained by the UAV, for example, a specific area flight license, a specific time period (e.g., nighttime) flight license, or the like.

At 508, the electronic signature server 20 queries the certificate database 30 according to the query request to obtain the certificate that matches the query request. The electronic signature server 20 can search for the certificate stored in the certificate database 30 based on the identification information. In some embodiments, the electronic signature server 20 can compare the identification information of the user with the identification information included in the electronic signature bound with the certificate to determine whether the certificate matches the identification information of the user.

At 510, the electronic signature server 20 generates the query result according to the query request. If the certificate matching the query request is found, the query result can include the found certificate, but if the certificate corresponding to the query request is not found, the query result can include a “not found” prompt.

At 512, the electronic signature server 20 returns the query result to the electronic signature terminal 10.

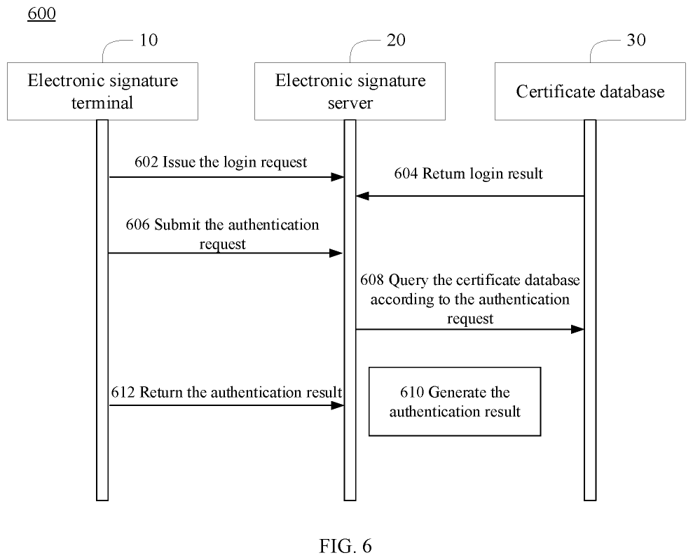

FIG. 6 is a schematic flow chart of another example electronic signature method 600 consistent with the disclosure. The electronic signature method 600 includes an authentication process. An order of the processes in FIG. 6 can be changed according to different requirements, and some processes may be omitted or combined.

At 602, the electronic signature terminal 10 issues the login request according to the user operation. In some embodiments, the electronic signature terminal 10 can be installed with the electronic signature application, and when the electronic signature application is opened and the user name and password are inputted, the login request can be issued. In some embodiments, the electronic signature terminal 10 can enter the electronic signature interface by via the predetermined web address, and when the electronic signature process is triggered by clicking the one or more buttons on the electronic signature interface, the login request can be issued.

At 604, after receiving the login request, the electronic signature server 20 determines whether the user is allowed to log in. The login request information can include the account password or other identification features, such as the sounds, gestures, or the like. The login module 201 can compare the identification features in the login request information with the pre-stored identification features, and can allow the login request if they are consistent, and does not allow the login request if they are inconsistent.

At 606, the electronic signature terminal 10 submits the authentication request according to the user operation. The authentication request can include, but not limited to, the identification information of the user, the type and/or name of the found certificate. In some embodiments, the type of the certificate can include, but not limited to, the registration certificate, the airworthiness certificate, the driver's license, or the like. The registration certificate can include, but not limited to, the personnel registration certificate, the UAV registration certificate, the ground station registration certificate, and the like. The airworthiness certificate can include the flight authority license or the certification certificate obtained by the UAV, for example, the specific area flight license, the specific time period (e.g., nighttime) flight license, or the like.

At 608, the electronic signature server 20 queries the certificate database 30 according to the authentication request to determine whether the user passes the authentication. The electronic signature server 20 can search for the certificate stored in the certificate database 30 based on the identification information. If the certificate corresponding to the authentication request is found, it is determined that the user passes the authentication. In some embodiments, the electronic signature server 20 can compare the identification information of the user with the identification information included in the electronic signature bound with the certificate to determine whether the certificate matches the identification information of the user.

At 610, the electronic signature server 20 generates an authentication result according to the authentication request. If the certificate matching the authentication request is found, the authentication result can include “passed authentication,” but if the certificate matching the authentication request is not found, the query result can be a prompt of “failed to pass the authentication.”

At 612, the electronic signature server 20 returns the authentication result to the electronic signature terminal 10.

It is intended that the embodiments disclosed herein are merely for illustrating the technical solutions of the present disclosure and not to limit the scope of the disclosure. Changes, modifications, alterations, and variations of the above-described embodiments may be made by those skilled in the art without departing from the scope of the disclosure.

What is claimed is:

1. An electronic signature system comprising:
an electronic signature terminal configured to issue an electronic signature request and submit certificate information of a certificate;
an electronic signature server configured to generate an electronic signature based on the electronic signature request and bind the electronic signature with the certificate information; and
a certificate database configured to store the certificate information bound with the electronic signature.

2. The system of claim 1, wherein the certificate includes at least one of an unmanned aerial vehicle (UAV) registration certificate, a UAV airworthiness certificate, or a UAV operator license.

3. The system of claim 1, wherein the electronic signature request includes identification information of a user and electronic signature information.

4. The system of claim 3, wherein the electronic signature information includes at least one of a signature of the user or an identification feature of a fingerprint of the user.

5. The system of claim 1, wherein:
the electronic signature terminal is further configured to issue a query request; and
the electronic signature server is further configured to query, according to identification information of a user in the query request, the certificate database for a target certificate bound to a target electronic signature matching the identification information.

6. The system of claim 1, wherein:
the electronic signature terminal is further configured to issue an authentication request; and
the electronic signature server is further configured to:
query, according to identification information of a user in the authentication request, the certificate database for a target certificate bound with a target electronic signature matching the identification information; and
determine that the user passes authentication in response to finding the target certificate.

7. The system of claim 1, wherein the electronic signature terminal is communicatively coupled to the electronic signature server via one or more of a wired connection, a Bluetooth connection, an infrared connection, a WiFi connection, and a mobile communication network.

8. The system of claim 1, wherein the electronic signature terminal includes a smart terminal, a UAV remote controller, or a ground station.

9. An electronic signature server comprising:
a storage device storing a plurality of instructions; and
a processor coupled to the storage device and configured to execute the plurality of instructions to:
receive an electronic signature request and a certificate;
generate an electronic signature based on the electronic signature request;
bind the electronic signature with the certificate; and
store the certificate bound with the electronic signature to a certificate database.

10. The server of claim 9, wherein the certificate includes at least one of an unmanned aerial vehicle (UAV) registration certificate, a UAV airworthiness certificate, or a UAV operator license.

11. The server of claim 9, wherein the electronic signature request includes identification information of a user and electronic signature information.

12. The server of claim 11, wherein the electronic signature information includes at least one of a signature of the user or an identification feature of a fingerprint of the user.

13. The server of claim 9, wherein the processor is further configured to execute the plurality of instructions to:
receive a query request; and
query, according to identification information of a user in the query request, the certificate database for a target certificate bound to a target electronic signature matching the identification information.

14. The server of claim 9, wherein the processor is further configured to execute the plurality of instructions to:
receive an authentication request;
query, according to identification information of a user in the authentication request, the certificate database for a target certificate bound with a target electronic signature matching the identification information; and
determine that the user passes authentication in response to finding the target certificate.

15. An electronic signature method comprising:
receiving an electronic signature request and a certificate;
generating an electronic signature based on the electronic signature request;
binding the electronic signature with the certificate; and
storing the certificate bound with the electronic signature to a certificate database.

16. The method of claim 14, wherein the certificate includes at least one of an unmanned aerial vehicle (UAV) registration certificate, a UAV airworthiness certificate, or a UAV operator license.

17. The method of claim 14, wherein the electronic signature request includes identification information of a user and electronic signature information.

18. The method of claim 17, wherein the electronic signature information includes at least one of a signature of the user or an identification feature of a fingerprint of the user.

19. The method of claim 14, further comprising:
receiving a query request; and
querying, according to identification information of a user in the query request, the certificate database for a target certificate bound to a target electronic signature matching the identification information.

20. The method of claim 14, further comprising:
receiving an authentication request;
querying, according to identification information of a user in the authentication request, the certificate database for a target certificate bound with a target electronic signature matching the identification information; and
determining that the user passes authentication in response to finding the target certificate.
